(19) United States
(12) Patent Application Publication
(10) Pub. No.: US 2005/0125287 A1
(43) Pub. Date: Jun. 9, 2005

(54) Method and system for learning consumer behaviour

(76) Inventors: Rajendra Sureka, New Delhi (IN); Vishal Singh Batra, Pin (IN)

Correspondence Address: Frederick W. Gibb, III;McGinn & Gibb, PLLC, Suite 304, 2568-A Riva Road, Annapolis, MD, 21401, US

(21) Appl. No.: 10/727,776

(22) Filed: Dec. 4, 2003

(51) Int. Cl. G06F 17/60

(52) U.S. Cl. 705/14

(57) ABSTRACT

Methods, systems and computer program products for learning consumer behavior are disclosed. A shared business opportunity with a merchant is offered to selected parties. Parent parties that accept the shared business opportunity are in turn enabled to offer a shared business opportunity to selected child parties. Each ancestor of one of the selected child parties is compensated in response to an online transaction between that child party and the merchant. Consumer behavior of a target party is predicted based on consumer behavior of at least one descendant party of the target party.

### FIELD OF THE INVENTION

The present invention relates to learning consumer behaviour for more effectively promoting business.

### BACKGROUND

Advertising campaigns and initiatives are the backbone of a business' promotional activities. Sales promotional tools such as discounts, coupons, freebies, gift certificates, etc., are inviting to new customers and assist in retaining existing customers. However, it is becoming increasingly difficult for businesses to maintain marketing expenditure, whilst maintaining profit levels over a period of time.

Online merchants have long sought to better understand consumer behaviour as such can be crucial to the success of an online store. Data relating to consumers' behaviour is useful for business intelligence and subsequent targeting of promotional activities. However, effective learning of consumer behaviour typically requires large sets of data, which can prove costly to collect. Moreover, merchants frequently lack an appropriate level of decision support. An effective decision support system would therefore assist a merchant to target promotional activities.

Various methods exist of promoting business such as the formation of customer-chains through customer referrals, which may be represented in a tree-like data structure. However, intelligent information relating to such a data structure may be useful in assisting a merchant to better understand consumer behaviour and support important business decisions. Such decisions may comprise the selection of appropriate sales promotional tools for targeting of specific customers.

The online business Quixtar Inc., which can be accessed via the Internet at the website <wvw.uuixtar.com>, uses a methodology of establishing an Independent Business Ownership (IBO) model with members. Members are preferred customers who pay an annual membership fee to obtain products at membership prices. The Quixtar Inc. website does not, however, appear to collect data for learning consumer behaviour.

There is thus a need for methods and systems for learning consumer behaviour.

### SUMMARY

Aspects of the present invention provide methods, systems and computer program products for learning consumer behaviour.

According to one aspect, a hierarchical representation of relationships formed between a merchant and a plurality of parties is generated based on referrals to the merchant of certain of the parties by other of the parties. Data relating to online transactions between the parties and the merchant is obtained and processed. Consumer behaviour of a target party is predicted based on selected data relating to at least one party on a lower level in the hierarchical representation than the target party. The selected data is selected from the processed data.

According to another aspect, a shared business opportunity with a merchant is offered to selected parties. Parent parties that accept the shared business opportunity are in turn enabled to offer a shared business opportunity to selected child parties. Each ancestor of one of the selected child parties is compensated in response to an online transaction between that child party and the merchant. Consumer behaviour of a target party is predicted based on consumer behaviour of at least one descendant party of the target party.

### BRIEF DESCRIPTION OF THE DRAWINGS

Features and embodiments of the present invention are described hereinafter, by way of example only, with reference to the accompanying drawings in which:

FIG. 1 is a flow diagram of a method for generating a representation of customer relationships based on shared business opportunities between customers and a merchant;

FIG. 2 is another flow diagram of a method for generating a representation of customer relationships based on shared business opportunities between customers and a merchant;

FIG. 3 is a schematic diagram of a tree structure that is representative of relationships formed between customers and a merchant;

FIG. 4 is a flow diagram of a method for learning consumer behaviour;

FIG. 5 is a flow diagram of another method for learning consumer behaviour; and

FIG. 6 is a schematic representation of a computer system suitable for practising embodiments described hereinafter.

### DETAILED DESCRIPTION

Embodiments of methods, systems and computer program products for learning consumer behaviour are described hereinafter.

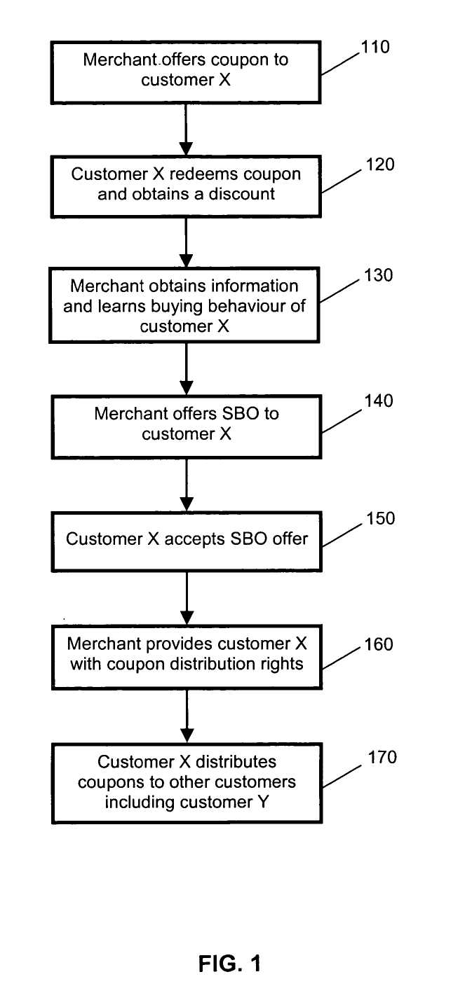

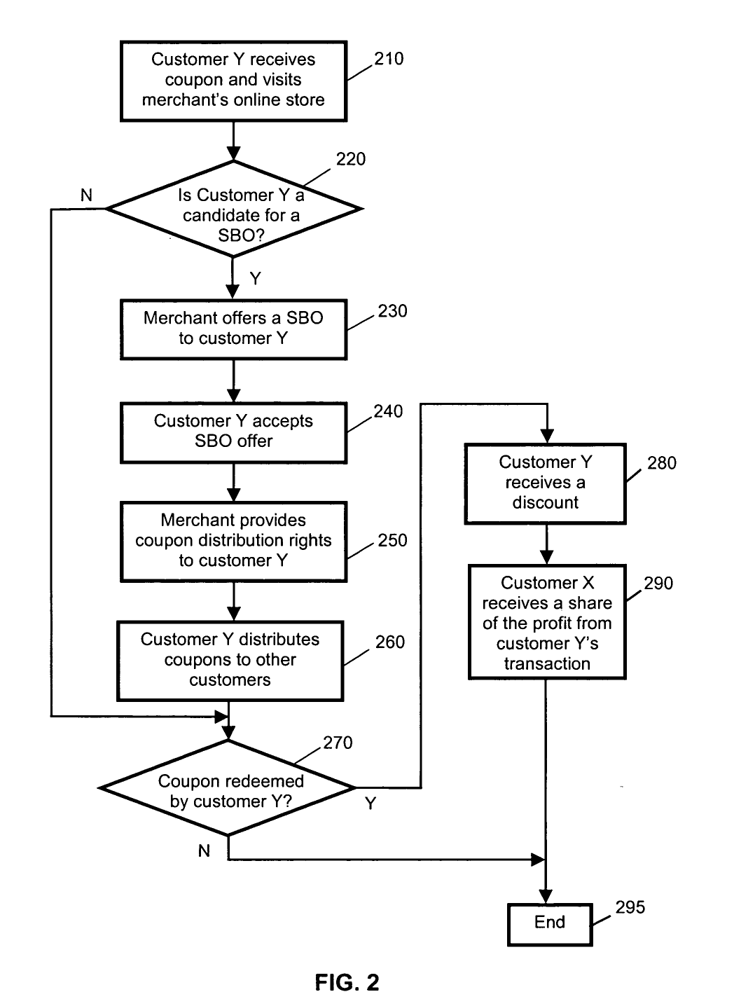

FIGS. 1 and 2 show flowcharts of a method for generating a representation of customer relationships based on shared business opportunities between customers and a merchant.

At step 110, the merchant offers one or more coupons to an existing customer X. While the present embodiment is described with respect to coupons (e.g., discount coupons), other sales promotional tools may be offered in place of, or together with such coupons. Other such sales promotional tools may comprise freebies, gift certificates, etc.

At step 120, the customer X redeems the coupon during a transaction and obtains an immediate benefit in the form of a discount.

Information relating to the transaction is obtained by the merchant at step 130, for assisting the merchant to learn the buying habits of the customer X.

Based on the information obtained in step 130, the merchant offers a shared business opportunity (SBO) to the customer X to promote business at step 140. The SBO is of benefit to the customer X in terms of future profit sharing and discounts.

At step 150, the customer X accepts the SBO and registers as a business partner via the merchant's website. After registration by the customer X, the merchant provides the customer X with the right to distribute coupons, at step 160. An agreement or arrangement is also automatically formed between the merchant and the customer X for keeping track of coupons distributed by the customer X. This facilitates identification of the coupon distributor when the coupons are subsequently redeemed. Coupons may, for example, be identified by a unique number or token, or by means of a Universal Resource Locator (URL) that is requested by a recipient of a coupon. However, other schemes for coupon identification may also be practised, as would be understood by persons skilled in the art. Identification assists the merchant to track coupon attributes as well as coupon distributors.

At step 170, the merchant offers promotional tools such as e-coupons (electronic coupons) to the customer X for distribution among friends, colleagues, relatives, etc. of the customer X. The promotional tools may, for example, be distributed via e-mail, Short-Messaging-Service (SMS), or a merchant-facilitated sub-store such as a website administered by the customer X.

Turning now to FIG. 2, the customer Y is representative of a recipient of an e-coupon from the customer X.

At step 210, the customer Y visits the merchant's online store. The customer Y is typically required to enter a coupon token provided by the customer X for authentication. As described hereinbefore, a coupon token may be a unique identifier for a coupon (e.g., a unique number or code), which assists a merchant to identify properties of the coupon and the coupon distributor (e.g., customer X). This information may further be of assistance in determining whether the customer Y is an eligible candidate for a SBO. However, the use of coupon tokens also enables unregistered customers to participate, thus ensuring a broader market coverage. Accordingly, the coupon tokens may simply indicate coupon usage and no explicit authentication of a customer may be necessary. Alternatively, the customer Y may explicitly provide some identifier for the customer X such as an email ID or customer ID. Optionally, the customer Y can indicate an interest in a shared business opportunity (SBO) with the merchant and/or provide an email address to enable contact by the merchant. The background electronic transaction enabling system identifies the promotional tool used by a customer and the distributor of the promotional tool. Thus, the e-coupon used by the customer Y for the transaction and the associated distributor (customer X) are identified. System security is also improved by use of a coupon token. Thus, each of the merchant, the first-level customer X and the second-level (referred) customer Y benefit from transactions between the customer Y and the merchant. The merchant typically shares the profit generated by customer Y's transaction with customer X, although other forms of compensation scheme are possible. At step 220, the merchant identifies whether the customer Y is a candidate for a SBO based on buying habits of the customer Y. The customer Y should preferably be a registered customer of the merchant in order to be a candidate for a SBO. Registration involves the provision of information such as a preferred customer ID, demographic information, personal details, age, location, etc. Such information, which can be provided online, enables improved targeting of customers by the merchant. Moreover, if the customer Y accepts the SBO, registration and login are likely essential for security reasons. Notwithstanding the foregoing, certain embodiments may only require an email ID for the customer Y and registration may not be necessary. If the customer Y is a candidate for a SBO (Y), the merchant offers a SBO to the customer Y at step 230. The customer Y accepts the SBO offer at step 240, the merchant provides promotional tool distribution rights or coupon distribution rights to the customer Y at step 250, and the customer Y distributes promotional tools at step 260. The promotional tools may, for example, be distributed via e-mail, Short-Messaging-Service (SMS), or a merchant-facilitated sub-store to friends, colleagues, relatives, etc. of customer Y. Processing continues at step 270. If the customer Y is not a candidate for a SBO (N), processing goes directly from step 220 to step 270.

If the customer Y redeems the e-coupon (Y) at step 270, the customer Y receives a transaction discount at step 280. At step 290, the customer X receives a share of the profit from customer Y's transaction.

In a similar manner, all future transactions involving the customer Y also benefit the customer X. The backend transaction processing system keeps track of the fact that the customer Y was referred to the merchant by the customer X by generating a customer referral graph. The graph may take the form of a simple tree or a complex graph, wherein each node represents a customer. In this way, the profit generated from a transaction between a customer and the merchant is shared with all the referring customers, who are represented by ancestor or parent nodes of the customer node in the customer referral graph. An initially small tree may grow into a graph, thus enabling the customer relationship chain to be cascaded from one SBO to another.

As more registered customers enter into a SBO with the merchant, the customer referral graph grows and data relating to the customers' buying behaviour may be collected and recorded. Various statistical and sophisticated learning techniques can be applied to the data to produce information useful to the merchant. For example, such information may enable the merchant to segment customers and offer promotional schemes on appropriately selected products/brands. The customers will also benefit by receiving promotional schemes targeted to their specific interests and demands. The customer graph may also be mathematically analyzed to compute appropriate discount levels for maximizing the merchant's profit.

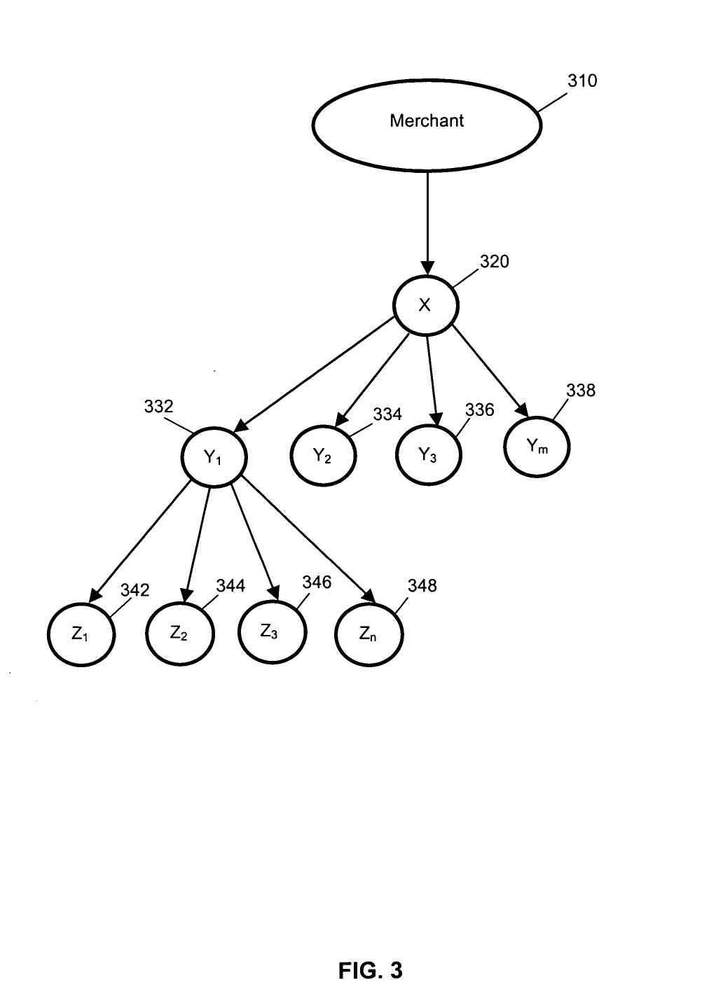

FIG. 3 shows a tree structure that is representative of relationships formed between customers and a merchant.

The node 320 represents customer X, who is a direct customer of a merchant 310. The nodes 332, 334, 336 and 338 represent customers Y₁ to Yₘ that were referred to the merchant by the customer X. The profit from any transactions between the merchant and customers Y₁ to Yₘ is thus shared with the customer X.

The nodes 342, 344, 346 and 348 represent customers Z₁ to Zₙ that were referred to the merchant by the customer Y₁. However, the customer Y₁ was referred to the merchant by the customer X. Thus, the profit from any transactions between the merchant and customers Z₁ to Zₘ is shared with the customers X and Y₁.

The customers X and Y, are ancestors of each of the customers Z₁ to Zₙ. In a related manner, each of the customers Y₁ to Yₘ and the customers Z₁ to Zₙ are descendants of the customer X. Furthermore, each of the customers Z₁ to Zₙ are descendants of the customer Y₁.

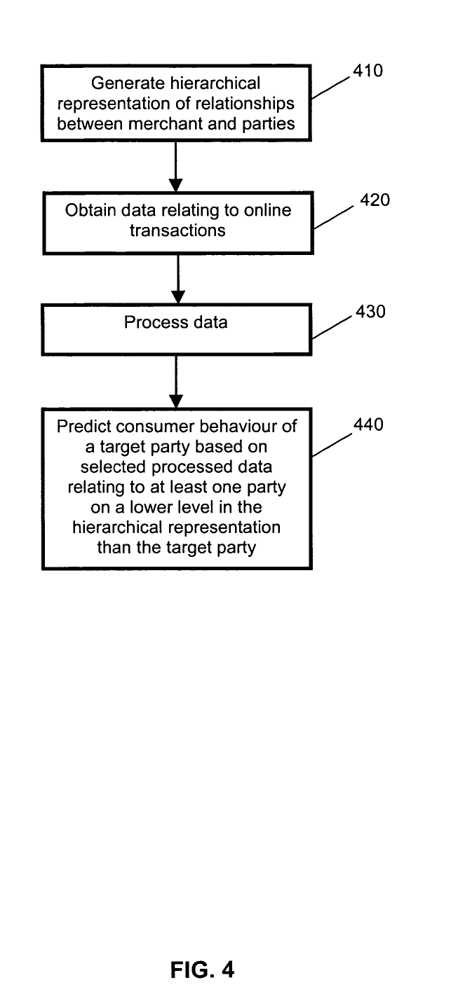

The tree structure of FIG. 3 potentially provides the merchant with a large amount of data from which intelligent information may be extracted to assist the merchant in learning consumer behaviour more efficiently:
By considering the usage patterns of a customer, the merchant may better know which advertisement or promotion would appeal more to that customer. Thus, the merchant can select promotional tools for more effectively targeting a customer.
The previous buying behaviour of a customer may assist the merchant to identify brand preferences of the customer.
Once the merchant learns customer preferences, for example by analyzing how a customer redeems a coupon, factors such as what category of people the customer forwards promotional coupons to and how the referenced person uses the forwarded coupon assist the merchant in learning the customer and the referenced person's behaviour. This information may assist the merchant to segment customers with similar profiles and likings for effective personalized targeting and, hence, improved brand positioning.
The merchant may apply learning techniques to identify optimal price levels for products and/or services offered to customers.
The merchant may better be able to maximize the probability of success of a particular promotion. Suppose the merchant sends 5 coupons to a customer and expects all of the coupons to be utilized. It is unlikely, however, that all of the 5 recipients will redeem the coupons. Accordingly, the merchant may forward a single Universal Resource Locator (URL), which points to where the coupons are available, and encourage the customer to forward the URL to as many acquaintances or contacts as possible. As the number of recipients increases, so will the probability of redemption of coupons. However, this may lead to a situation where too many recipients wish to redeem coupons. Accordingly, the merchant may impose a redemption condition such as “the first 5 recipients who visit the URL and redeem the coupon obtain the benefit”. Other recipients may or may not obtain the benefit at the merchant's discretion.
Purchasing behaviour and usage patterns of a customer may help the merchant learn the preferences of an ancestor of that customer. Hence, movement along the tree in the reverse direction can yield useful information about parent and ancestor nodes, which may otherwise not be revealed. FIG. 4 shows a flow diagram of a method for learning consumer behaviour.

A hierarchical representation of relationships formed between a merchant and a plurality of parties is generated at step 410. The representation is based on referrals of certain of the parties to the merchant by others of the parties. The representation may comprise a tree structure of hierarchically arranged nodes corresponding to the parties, wherein each party represented by a child node corresponds to a party referred to the merchant by the party represented by a respective parent node. The representation may optionally be generated by the merchant and the parties typically comprise customers or potential customers of the merchant.

At step 420, data relating to online transactions between the parties and the merchant is obtained. The online transactions may comprise redemption of a sales promotional tool such as discount coupons valid for all items offered by the merchant, discount coupons valid for a selected group of items offered by the merchant, discount coupons valid for a particular item offered by the merchant, gift certificates, or freebies.

The data obtained in step 420 is processed at step 430. Such processing may comprise one or more of correlation analysis, collaborative filtering, associative learning and any other appropriate techniques known in the art of data processing.

At step 440, consumer behaviour of a target party is predicted. The prediction is based on selected data relating to at least one party on a lower level in the hierarchical representation than the target party. The selected data may be selected according to one or more of the following criteria: demographics of the at least one party, acquaintances of the at least one party, past transactions of the at least one party, and clickstream patterns of the at least one party.

### EXAMPLE

Suppose a merchant provides n promotional tools (e.g., discount coupons) to an existing customer X for distribution. Each promotional tool may be applicable to the merchant's entire range of items offered, a specific category of item, or a specific item. Assuming that each of the promotional tools apply to a specific category of item:

The set of promotional tools P={P₁, P₂, . . . Pₙ).

The set of categories C={C₁, C₂, . . . . Cₘ).

Applicability of a promotional tool to a particular category is defined as Aᵢⱼ, where iε(1,n) is a promotional tool applicable to category jε(1,m).

Here, one or more elements in P can map to one or more elements in C. Thus, one representation of A could be as under:
Aᵢⱼ={A₁₁,A₁₂,A₂₁ . . . Aₙₘ}

Based on the usage patterns of a set of customers Y, which may comprise a subset of the set of acquaintances of customer X who received promotional tools, learning techniques can be applied to learn the potential buying behaviour of all the ancestors of the set of customers Y.

For example, suppose a customer distributes discount coupons applicable to certain items to acquaintances such as friends, family, etc. The manner in which the acquaintances utilize the coupons on the merchant's website provides an indication to the merchant as to which class of society the customer belongs to, what kind of people the customer knows, the customer's own spending pattern, etc. For example, the consumer behaviour of an acquaintance purchasing a car is different compared to that of an acquaintance purchasing a motorbike.

Specifically, by processing data while moving in a reverse (bottom to top) direction up the tree, the buying behaviour and usage patterns of the customer X can be predicted. This bottom-up approach can thus be used to predict intelligent information about the customer X, which may not be directly available, but which can be inferred from the behaviour of descendents of the customer X.

Usage patterns of customers may comprise, but are not limited to, the manner in which the promotional tools are redeemed and to which category the promotional tools belong to. As an example, the number of occurrences of j (i.e., a particular category of item) in the set Aᵢⱼ indicates the relative importance of that category for the descendants of the customer X. Promotional tools relating to the category j can thus be targeted at the descendents of the customer X. The customer X is also an important target for the promotion of items in category j, as well as for the distribution of further promotional tools relating to category j (e.g., discount coupons for items in category j, etc.).

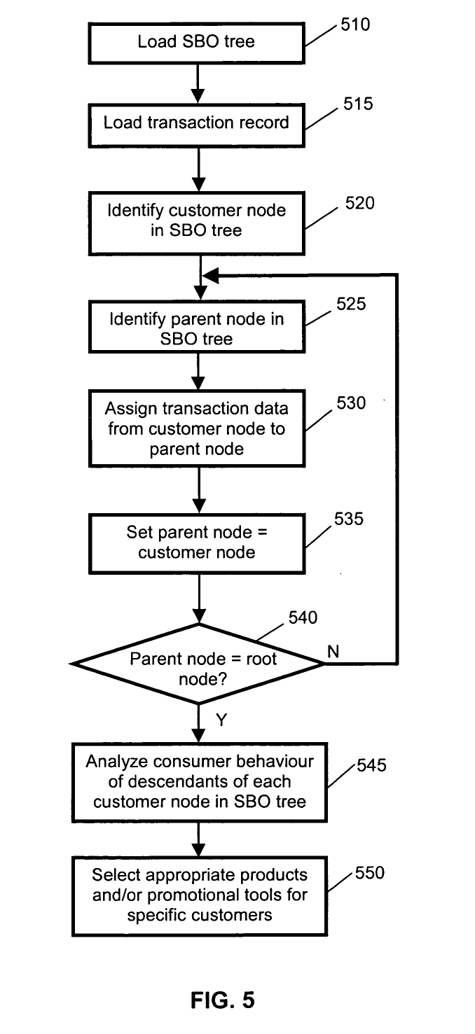

FIG. 5 shows another flow diagram of a method for learning consumer behaviour.

An SBO tree is loaded or made available for accessing at step 510 and a particular transaction record is selected and loaded at step 515. A transaction record typically comprises data such as customer ID, product ID, transaction amount, etc. At step 520, the node in the SBO tree that is representative of the customer in the transaction record loaded in step 515 is identified. The customer node may be identified based on the customer ID, which is retrieved from the transaction record. At step 525, the parent node of the customer node identified in step 520, is identified. Data relating to the transaction is assigned from the customer node to the parent node at step 530 for tracking of ancestors for compensation or profit sharing as described hereinbefore. At step 535, the parent node is set to the selected customer node. If the new customer node (previous parent node) is the root node of the SBO tree (Y), at step 540, the consumer behaviour of the descendants of each customer node in the SBO tree is analysed at step 545. Any appropriate techniques or algorithms known in the art, such as correlation analysis, collaborative filtering and associative learning, may be applied to the transaction data assigned in step 530 for such analysis. At step 550, the results of the analysis are used to select appropriate products and/or promotional tools for specific customers.

If the new customer node (previous parent node) is not the root node of the SBO tree (N), at step 540, processing reverts to step 525.

Although FIG. 5 shows processing of a single transaction record, steps 515 to 540 may be repeated for multiple transaction records.

This reverse targeting technique not only predicts the interests and/or preferences of the descendants of the customer X, but also suggests that the customer X can be lured towards items in category j and thus makes the customer X an effective target for such promotional tools. Various other learning techniques can also be applied to the SBO tree data to learn more about the consumer behaviour. Examples of such learning techniques comprise correlation analysis, collaborative filtering, and associative learning.

Computer Hardware and Software

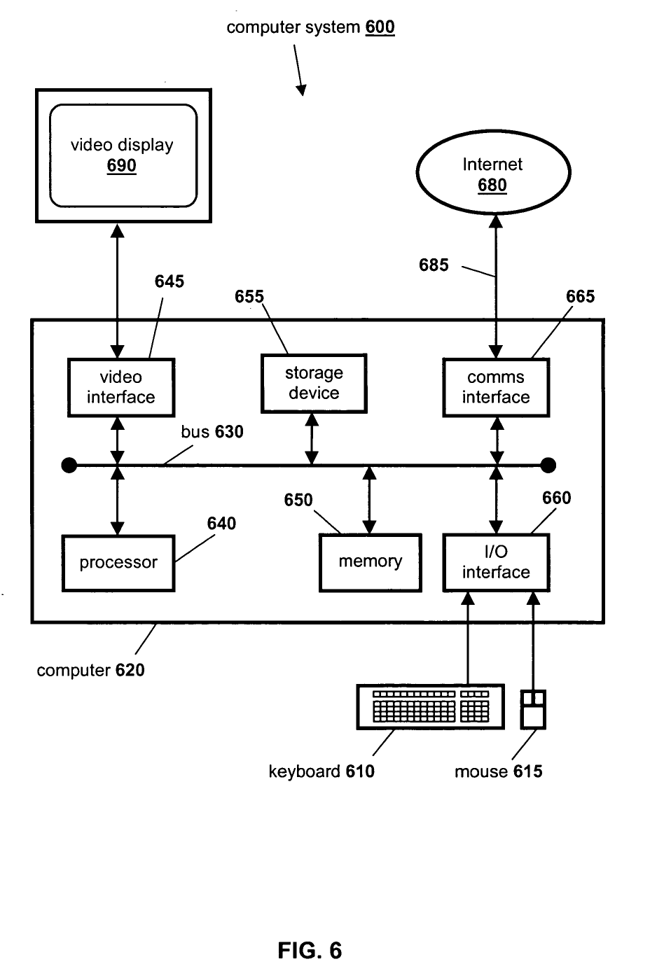

FIG. 6 is a schematic representation of a computer system 600 that can be used to practise the methods described herein for learning consumer behaviour. The computer system 600 is provided for executing computer software that is programmed to assist in performing the step of the described methods. This computer software executes under a suitable operating system such as MSWindows XP™ or Linux™ installed on the computer system 600.

The computer software involves a set of programmed logic instructions that may be interpreted by the computer system 600 for instructing the computer system 600 to perform predetermined functions specified by those instructions. The computer software can be an expression recorded in any language, code or notation, comprising a set of instructions intended to cause a compatible information processing system to perform particular functions, either directly or after conversion to another language, code or notation.

The computer software comprises statements in an appropriate computer language. The computer program may be processed using a compiler into computer software that has a binary format suitable for execution by the operating system. The computer software is programmed in a manner that involves various software components, or code means, that perform particular steps of the methods described hereinbefore.

The components of the computer system 600 include: a computer 620, input devices 610, 615 and a video display 690. The computer 620 includes: a processing unit 640, a memory unit 650, an input/output (I/O) interface 660, a communications interface 665, a video interface 645, and a storage device 655.

The processing unit 640 may comprise one or more processors that execute the operating system and the computer software executing under the operating system. The memory unit 650 may comprise random access memory (RAM), read-only memory (ROM), flash memory, and/or any other type of memory known in the art for use under direction of the processing unit 640.

The video interface 645 is connected to the video display 690 and provides video signals for display on the video display 690. User input to operate the computer 620 is provided from input devices 610, 615, which may comprise a keyboard and a mouse. The storage device 655 may comprise a disk drive or any other suitable non-volatile storage medium.

Each of the components of the computer 620 is connected to a bus 630 that comprises data, address, and control buses, to allow these components to communicate with each other via the bus 630.

The computer system 600 can be connected to one or more other similar computers via a input/output (I/O) interface 665 using a communication channel 685 to a network 680, represented as the Internet.

The computer software program may be provided as a computer program product, and recorded on a portable storage medium. In this case, the computer software program is accessed by the computer system 600 from the storage device 655. Alternatively, the computer software can be accessed directly from the network 680 by the computer 620. In either case, a user can interact with the computer system 600 using the keyboard 610 and mouse 615 to operate the programmed computer software executing on the computer 620.

The computer system 600 has been described for illustrative purposes. Accordingly, the foregoing description relates to an example of a particular type of computer system suitable for practising the methods and/or computer program products described hereinbefore. Other configurations or types of computer systems can be equally well used to practise the methods and/or computer program products described hereinbefore, as would be readily understood by persons skilled in the art.

### Conclusion

The embodiments described hereinbefore for learning consumer behaviour advantageously reduce marketing and promotional costs and provide a rich customer data set for the application of business analytics.

The embodiments described hereinbefore have industrial application, at least in that such may be incorporated into new commercial websites and existing commercial websites such as WebSphere T Commerce Suite and WebSphere T Commerce Analyzer.

The foregoing detailed description provides exemplary embodiments only, and is not intended to limit the scope, applicability or configurations of the invention. Rather, the description of the exemplary embodiments provides those skilled in the art with enabling descriptions for implementing an embodiment of the invention. Various changes may be made in the function and arrangement of elements without departing from the spirit and scope of the invention as set forth in the claims hereinafter.

1. A method for learning consumer hour behavior, said method comprising the steps of:
generating a hierarchical representation of relationships formed between a an online merchant and a plurality of online parties, said representation based on referrals to said merchant of certain of said parties by other of said parties;
obtaining data relating to online transactions between said parties and said merchant; processing said data; and
predicting consumer behavior of a target party based on selected data relating to at least one party on a lower level in said hierarchical representation than said target party, said selected data selected from the processed data.

2. The method of claim 1, wherein said re-presentation comprises a tree structure of hierarchically arranged nodes corresponding to said parties.

3. The method of claim 2, wherein each party represented by a child node in said tree structure is referred to said merchant by the party represented by a respective parent node in said tree structure.

4. The method of claim 3, comprising the further step of providing compensation to each ancestor of a party that performs a transaction with said merchant.

5. The method of claim 4, wherein said compensation comprises a share of te profit generated by said transaction.

6. The method of claim 1, wherein said selected data comprises data relating to at least one of:
demographics of said at least one party;
acquaintances of said at least one party past transactions of said at least one party; and
click stream patterns of said at least one party.

7. The method of claim 1, wherein said online transactions comprise redemption of a sales promotional tool selected from the group of sales promotional tools comprising any of:
discount coupons valid for all items offered by said merchant;
discount coupons valid for a selected group of items offered by said merchant;
discount coupons valid for a particular item offered by said merchant;
gift certificates; and
freebies.

8. The method of claim 1, wherein said processing step comprises applying at least one technique comprising any of:
correlation analysis;
collaborative filtering; and
associative learning.

9. The method of claim 1, comprising any of:
determining pricing for items offered by said merchant;
performing market segmentation of said parties;
identifying preferences of said target party;
identifying, sales promotional tools relevant to said target party;
performing marketing targeted at an identified market segment;
performing marketing targeted at said target party; and
maximizing the potential success of a promotional tool.

10. The method of claim 1, comprising the further step of providing incentives to said parties to form said relationships.

11. A method for learning consumer behavior, said method comprising the steps of:
offering a shared business opportunity with a an online merchant to selected online parties;
enabling parent parties that have accepted said shared business opportunity to offer a shared business opportunity to selected child parties;
compensating each ancestor of one of said selected child parties in response to an online transaction between said child party and said merchant; and
predicting consumer behavior of a target party based on consumer behavior of at least one descendant party of said target party.

12. The method of claim 11, further comprising the step of providing incentive to said parties to accept said shared business opportunity.

13. A system for learning consumer behavior, said system comprising:
at least one communications interface operable for transmitting and receiving data;
a memory unit operable for storing data and instructions to be performed by a processing unit; and
a processing unit coupled to said at least one communications interface and said memory unit, said processing unit programmed to:
generate a hierarchical representation of relationships formed between an online merchant and a plurality of parties, said representation indicative of referrals to said merchant of certain of said parties by other of said parties;
obtain data relating to online transactions between said parties and said merchant;
process said data; and
predict consumer behavior of a target party based on selected data relating to at least one party on a lower level in said hierarchical representation than said target party, said selected data selected from the processed data.

14. The system of claim 13, wherein said representation comprises a tree structure of hierarchically arranged nodes corresponding to said parties.

15. The system of claim 14, wherein each party represented by a child node in said tree structure is referred to said merchant by the party represented by a respective parent node in said tree structure.

16. The system of claim 15, wherein said processing unit is further programmed to determine a compensation for each ancestor of a party that performs a transaction with said merchant.

17. The system of claim 16, wherein said compensation comprises a share of profit generated by said transaction.

18. The system of claim 13, at least one of:
demographics of said at least one party;
acquaintances of said at least one party;
past transactions of said at least one party; and
clickstream patterns of said at least one party.

19. The system of claim 13, wherein said online transactions comprise redemption of a sales promotional tool selected from the group of sales promotional tools comprising any of:
discount coupons valid for all items offered by said merchant;
discount coupons valid for a selected group of items offered by said merchant;
discount coupons valid for a particular item offered by said merchant;
gift certificates; and
freebies.

20. The system of claim 13, wherein said online transactions comprise redemption of a sales promotional tool selected from sales promotional tools comprising of:
correlation analysis;
collaborative filtering; and
associative learning.

21. The system of claim 13, comprising any of:
determine pricing for items offered by said merchant;
perform market segmentation of said parties;
identify preferences of said target party;
identify sales promotional tools relevant to said target party;
perform marketing targeted at an identified market segment;
perform marketing targeted at said target party; and
maximize the potential success of a promotional tool.

22. The system of claim 13, wherein said processing unit is further programmed to offer an incentive to said parties to form said relationships.

23. A system for learning consumer behavior, comprising:
at least one communications interface operable for transmitting and receiving data;
a memory unit operable for storing data and instructions to be performed by a processing unit; and
a processing unit coupled to said at least one communications interface and said memory unit, said processing unit programmed to:
offer a shared business opportunity with a an online merchant to selected online parties;
enable parent parties that have accepted said shared business opportunity to offer a shared business opportunity to selected child parties;
compensate each ancestor of one of said selected child parties in response to an online transaction between said child party and said merchant; and
predict consumer behavior of a target party based on consumer behavior of at least one descendant party of said target party.

24. The system of claim 23, wherein said processing unit is further programmed to offer an incentive to said parties to accept said shared business opportunity.

25. A computer program product comprising a computer readable medium comprising a computer program recorded therein for learning consumer behavior, said computer program product comprising:
computer program code means for generating a hierarchical representation of relationships formed between an online merchant and a plurality of online parties, said representation based on referrals to said merchant of certain of said parties by other of said parties;
computer program code means for obtaining data relating to online transactions between said parties and said merchant;
computer program code means for processing said data; and
computer program code means for predicting consumer behavior of a target party based on selected data relating to at least one party on a lower level in said hierarchical representation than said target party, said selected data selected from sod the processed data.

26. The computer program product of claim 25, wherein said representation comprises a tree structure of hierarchically arranged nodes corresponding to said parties.

27. The computer program product of claim 26, wherein each party represented by a child node in said tree structure is referred to said merchant by the party represented by a respective parent node in said tree structure.

28. The computer program product of claim 27, further comprising computer program code means for determining compensation for each ancestor of a party that performs a transaction with said merchant.

29. The computer program product of claim 28, wherein said compensation comprises a share of profit generated by said transaction.

30. The computer program product of claim 25, wherein said selected data comprises data relating to at least one of:
demographics of said at least one party;
acquaintances of said at least one party;
past transactions of said at least one party; and
clickstream patterns of said at least one party.

31. The computer program product of claim 25, wherein said online transactions comprise redemption of a sales promotional tool selected from promotional tools comprising, one of:
discount coupons valid for all items offered by said merchant;
discount coupons valid for a selected group of items offered by said merchant;
discount coupons valid for a particular item offered by said merchant;
gift certificates; and
freebies.

32. The computer program product of claim 25, wherein said processing step comprises applying at least one technique comprising any of:
computer program code means for correlation analysis;
computer program code means for collaborative filtering; and
computer program code means for associative learning.

33. The computer program product of claim 25, comprising any of:
computer program code means for determining pricing for items offered by said merchant;
computer program code means for performing market segmentation of said parties;
computer program code means for identifying preferences of said target party;
computer program code means for identifying sales promotional tools relevant to said target party;
computer program code means for performing marketing targeted at an identified market segment;
computer program code means for performing marketing targeted at said target party; and
computer program code means for maximizing the potential success of a promotional tool.

34. The computer program product of claim 25, further comprising computer program code means for providing incentives to said parties to form said relationships.

35. A computer program product comprising a computer readable medium comprising a computer program recorded therein for learning consumer behavior, said computer program product comprising:
computer program code means for offering a shared business opportunity with an online merchant to selected online parties;
computer program code means for enabling parent parties that have accepted said shared business opportunity to offer a shared business opportunity to selected child parties;
computer program code means for compensating each ancestor of one of said selected child parties in response to an online transaction between said child party and said merchant; and
computer program code means for predicting consumer behavior of a target party based on consumer behavior of at least one descendant party of said target party.

36. The computer program product of claim 35, further comprising computer program code means for providing incentives to said parties to accept said shared business opportunity.
